(19) United States
(12) Patent Application Publication
(10) Pub. No.: US 2023/0421643 A1
(43) Pub. Date: Dec. 28, 2023

(54) Social Connection System and Methods

(71) Applicant: Hussein Saad, Miami, FL (US)

(72) Inventor: Hussein Saad, Miami, FL (US)

(21) Appl. No.: 18/214,410

(22) Filed: Jun. 26, 2023

Related U.S. Application Data
(60) Provisional application No. 63/355,371, filed on Jun. 24, 2022.

(51) Int. Cl. H04L 67/306; G06Q 50/00

(52) U.S. Cl. CPC H04L 67/306; G06Q 50/01

(57) ABSTRACT

The present subject matter relates to systems and methods that assist users in connecting in an online environment subsequent to a missed real life connection. The systems and methods employ a specifically sequenced series of interrelated, privacy-centered technologies to connect only those users that have expressed mutual interest and consent. The systems and methods provide a safe and secure online platform through which people can find their real life missed connections, connect with others on their own terms, and reveal their identity only when they are confident they have connected with the right person.

### BACKGROUND OF THE INVENTION

This application claims the benefit of priority to U.S. Provisional Patent Application Ser. No. 63/355,371, filed on Jun. 24, 2022, the entire disclosure of which is hereby incorporated by reference.

### BACKGROUND OF THE INVENTION

The present subject matter relates generally to systems and methods that assist users in connecting in an online environment subsequent to a missed real life connection. The systems and methods employ a specifically sequenced series of interrelated, privacy-centered technologies to connect only those users that have expressed mutual interest and consent.

It is common for people to cross paths with one or more strangers in a given day. Even when there may be a mutual interest in connecting, circumstances often prevent people from interacting with one another during these random encounters. There are numerous factors that inhibit the real life interaction, including difficulty presented by the location (e.g., on the plane, in the subway, walking opposite directions, etc.), a fear of rejection, fleeting time, and so on. Sometimes, the circumstances make a real life connection feel as though it may be intrusive or inappropriate. Accordingly, there are likely millions of missed connections every day.

Conventional systems that attempt to solve the missed connection problem, such as newspaper missed connection postings or classified sites and various dating applications, are ineffective and inefficient. In many instances, these prior systems did not give people who were unable to meet an opportunity to connect on their own terms and disclose their identity only if they felt confident they were connecting with the right person. For example, posts to previous missed connection sites/applications may have been anonymous, but also may have been publicly viewable. Certain dating application instantly connected user's profiles when a match was made, which created privacy and anonymity concerns. As a result, a user may have been reluctant to share information for fear of being recognized.

Prior attempts to solve the missed connection problem have lacked the structure, security, and control necessary to facilitate secure, private, mutually consented connections. For example, many prior systems enable free text posting, which allows users to post anything in any form they desire. As a result, the posts could be difficult to search or filter. In addition, certain matching applications disclosed the respective matches to each other using social media platform or profiles, which created privacy issues, especially if the match was incorrect.

Studies have shown that people have concerns about using existing dating apps, including: personal safety issues; fake profiles and misleading chats, swipe fatigue, abusive messages, etc., and that a majority of people would prefer to meet in real life, rather than through a dating application.

Accordingly, there is a need for systems and methods that provide a safe and secure online platform through which people can find their real life missed connections and through which users can connect to others on their own terms and reveal their identity only when they are confident they have connected with the right person.

### BRIEF SUMMARY OF THE INVENTION

The present disclosure provides systems and methods systems and methods that employ a specifically sequenced series of interrelated, privacy-centered technologies to connect users that are looking for a real life missed connection after the users have expressed mutual interest and consent. Various examples of the systems and methods are provided herein.

The systems and methods taught herein enable users that have crossed paths in real life to anonymously and privately post to the system while providing parameters for the system to assist in identifying another user's corresponding matching post. Then, in response to the system identifying a matching post, the user can review the parameters of the match, choose whether to consent to an anonymous chat with the matched person, then, after consenting to a chat, choose whether to consent to share the user's profile with the matched person. Privacy is a core feature of the systems and methods and the ordered sequence of steps in the systems and methods taught herein is a key factor that enables the platform technology to provide the matching functions while maintaining the desired level of user control over privacy and anonymity.

A central feature of the systems and methods described herein are the user posts. Posts, and the tags associated therewith, are the basis for matching users in the systems and methods taught herein. The posts are described in further detail using the following hypothetical missed connection scenario as the basis for describing an embodiment of the systems and methods taught herein.

This hypothetical missed connection is between a man and a woman on the NYC subway F train on the night of Monday, Jul. 31, 2023. A man boarded the F train at Delancey St. and sat next to a woman in the second car from the front of the train. They smiled at each other a couple of times, she scrolled through Instagram, he took off his headphones, but he did not work up the nerve to say hi. She got off the train at Carroll St. after looking over at him one last time.

In one embodiment of the systems and methods taught herein, an example of a user post may include: a title or description; a location; a time interval; a picture for the look of the day; one or more tags; a user-controlled option whether to make the post publicly searchable; and a user-controlled option as to whether to include a picture. The picture may be a picture of the posting user, a picture of the person with whom the posting user is attempting to connect, a picture relevant to the location or circumstances of the missed connection, etc. By default, user posts are not visible to any other users of the platform. The inventive subject matter claimed herein is specifically directed to embodiments in which the users choose not to make their posts publicly searchable.

In the example provided above, when creating a post, a user provides the title or description. For example, based on the hypothetical missed connection described above, the user provided title or description for a post may be, “Was sitting next to you. We smiled at each other.” The user provided location may be, “NYC Subway—F Train. N.Y. 07/31/2023.” The user provided time interval may be, “08:45-09:00 PM 07/31/2023.”

The associated tags may include: (i) tags related to the user (e.g., Me); and (ii) tags related to the user's match (e.g., You). For example, in a post created by the man in the hypothetical missed connection scenario, the “You” tags may include: woman; Asian; delancyst; carrollst; darkhair; longhair; and Instagram. The “Me” may include: man; tattoo; beard; tall; delanceyst; carrollst; earphone; poloshirt; jeans; and casualshoes.

The associated tags may be entered manually by the user or determined automatically by the system from the title or description entered or the user profile selected. For example, the associated tags may be based on specific sets of filters applied to the post and profile data, such as, adjectives from the title or description of the post, data derived from a user's profile picture, or even more specific details such as seat numbers from the title or description for airplane posts. The associated tags entered might be a combination of both manual and/or automatic determination.

In some embodiments, tag matching parameters are provided by the users for each post they create. For example, in some embodiments, the user determines a minimum number of tags that must be matched by another's post in order to be considered a match. In other embodiments, specific user-identified tags must be matched by another's post in order to be considered a match. In still other embodiments, a user-specified percentage of tags must be matched by another's post in order to be considered a match. In yet other examples, combinations of these user-defined parameters may be used in determining a match. In other embodiments, the tag matching parameters are defined by the system without accounting for user input. In any of the embodiments, the tag matching parameters may be independently specified for and applied to each of the Me tags and You tags categories.

Embodiments of the systems and methods taught herein allow tagging of both permanent and nonpermanent attributes, as well as attributes that are specific to the situation. For example, users may use tags directed towards permanent attributes such as eye color, height, etc., as well as nonpermanent attributes such as clothing, accessories, hairstyle, etc. Similarly, the tags may be directed to attributes specific to the situation such as subway stations or seat numbers. A user may specify the number or percentage of permanent and/or nonpermanent attribute tags must match in order for the system to find a matching post. A user may also specify the exact tags that must match.

For example, in an embodiment in which a minimum number of tags must be matched, specific tags must be matched, and the matching parameters are applied independently to each of the You tags and the Me tags categories, a user may specify that a minimum of two tags in the You tags category must match and at least one of the two matching tags must be the tag “woman.” Similarly, the user may specify that a minimum of three tags in the Me tags category must match and two of the tags must be “man” and “beard.” In other embodiments, there may be system settings defining various levels of matching, for example, low, medium, and high. A low setting may require just a minimal number of tags to match, whereas a high setting may require a much more robust matching of tags between two posts.

Once the user creates and submits a user post, the system starts looking for matches with other posts using the tags and tag matching parameters provided by each user. In instances in which the system identifies one or matches, the system presents the user a listing of the matches. In addition, the user's post remains accessible to the user on a user dashboard to enable the user to edit the post should the user choose to do so. This post-editing feature empowers user to influence matches by dynamically selecting the tags they want others to have found on their post about them.

In one example, a user interface provides a list of matches to a user. When the user selects one of the matches, the system presents the user an option of whether or not to consent to chat with the matched user. Before deciding whether to consent to chat with the matched user, the system may show the user the manner in which the match was determined. For example, the system may present to the user the matching tags as well as the tags that were not matched in each of the user's posts. For example, the system may inform the user that the matching post included tags for “man,” “beard,” and “jeans,” but did not include tags for “tattoo” and “tall.” Similarly, the system may inform the user that the matching post included tags for “woman,” and “Asian,” but did not include “longhair.”

After viewing the one or more matching posts, including viewing information about the matching tags, the user may then consent to chat privately and anonymously with the matching user. The chat between the users will only occur after both user's consent. Either user may rescind consent/permission to chat with the other user at any time. At this point, neither user has access to any private information about the other user other than what each user personally shares in the chat.

After the users begin to chat, each of the user's may then choose whether to provide consent to share their profile with the matched user. Like with the consent to chat described above, either user may rescind consent/permission for the other user to view their profile at any time. In some examples of the systems and methods taught herein, mutual consent to profile access is the mechanism through which users can continue future interaction.

As demonstrated, the present subject matter teaches a unique matching system in which users are able to post privately about their missed connections, self-select identifying tags for each person in the missed connection, review the manner in which the system has determined a match has been found, choose whether to chat anonymously, and choose whether to share their profiles, thereby providing a safe and secure online platform through which people can find their real life missed connections through which users can connect to others on their own terms and reveal their identity only when they are confident they have connected with the right person.

In embodiments of the systems and methods taught herein, the system may access third-party data or other additional data not provided directly by the users' posts and can use such additional data to facilitate matches between posts. For example, consider another hypothetical missed connection scenario between two individuals on a given flight. A first airline operated the flight and the flight was marketed by the first airline's partner airlines. In one embodiment of the systems and methods taught herein, a first user post may include the operating flight number (e.g., DL1234), while a second user post may include the marketed flight number (e.g., AF4132). Using additional data not provided in the user submitted posts, the system may recognize that flights DL1234 and AF 4123 are matching flights.

In one example, a computing device includes: one or more processors; and one or more computer-readable devices in communication with the one or more processors, the one or more computer-readable devices including instructions that when executed by the one or more processors cause the one or more processors to perform operations comprising: receiving a first post from a first user device associated with a first user account, wherein the first post includes: a first title or a first description; a first location; a first time interval; and one or more first tags; receiving a second post from a second user device associated with a second user account, wherein the second post includes: a second title or a second description; a second location; a second time interval; and one or more second tags; identifying whether there is a match between the first post and the second post, wherein a match is determined when a specific set of tag matching parameters are satisfied between the first post and the second post; when the specific set of tag matching parameters are not satisfied between the first post and the second post, not allowing the first user account to view the second post, not allowing the second user account to view the first post, not allowing chat functionality between the first user account and the second user account, and not allowing profile viewing between the first user account and the second user account; when the specific set of tag matching parameters are satisfied between the first post and the second post, providing both the first user account and the second user account access to details related to the manner in which the tag matching parameters were satisfied, providing the first user account access to view the second post, providing the second user account access to view the first post, providing the first user account an option to enable chat functionality between the first user account and the second user account; and providing the second user account to enable chat functionality between the first user account and the second user account; after providing both the first user account and the second user account access to details related to the manner in which the tag matching parameters were satisfied, providing the first user account access to view the second post, providing the second user account access to view the first post, providing the first user account an option to enable chat functionality between the first user account and the second user account; and providing the second user account to enable chat functionality between the first user account and the second user account, when the one or more processers do not receive consent to enable chat functionality between the first user account and the second user account from both the first user account and the second user account, not allowing chat functionality between the first user account and the second user account and not allowing profile viewing between the first user account and the second user account; when the one or more processers receive consent to enable chat functionality between the first user account and the second user account from both the first user device and the second user device, providing chat functionality between the first user account and the second user account; after providing chat functionality between the first user account and the second user account, when the one or more processers do not receive consent to share the first user account profile with the second user account from the first user device and do not receive consent to share the second user account profile with the first user account from the second user account device, not allowing profile viewing between the first user account and the second user account; when the one or more processers receive consent to share the first user account profile with the second user account from the first user device and receive consent to share the second user account profile with the first user account from the second user account device, allowing profile viewing between the first user account and the second user account.

In some embodiments, the one or more first tags include one or more tags related to the first user and one or more tags related to a first missed connection and the one or more second tags include one or more tags related to the second user and one or more tags related to a second missed connection. The one or more first tags and the one or more second tags may each include permanent and nonpermanent attributes. The one or more first tags and the one or more second tags may include situational context tags that do not relate specifically to any of the first user, the second user, the first missed connection, or the second missed connection. The situational context tags may relate to a location, a time interval, etc.

In some embodiments, the user accounts determine the tag matching parameters for the posts. In other embodiments, the computing device determines the tag matching parameters for the posts. In still other embodiments, the tag matching parameters for some posts are user determined and the computing device determines the tag matching parameters for other posts.

In some embodiments, the tag matching parameters include specific tags that must match between the first post and the second post in order to satisfy the tag matching parameters. In some embodiments, the tag matching parameters include a number of tags that must match between the first post and the second post in order to satisfy the tag matching parameters. In some embodiments, the tag matching parameters include a percentage of tags that must match between the first post and the second post in order to satisfy the tag matching parameters.

An advantage of the present systems and methods is assisting users in connecting in an online environment subsequent to a missed real life connection.

A further advantage of the present systems and methods is the specific sequence of privacy-based steps strictly protects users anonymity and privacy and connects only those users that have expressed mutual interest and consent.

A further advantage of the present systems and methods is users can connect to others on their own terms and reveal their identity only when they are confident they have connected with the right person.

A further advantage of the present systems and methods is that the users may control the manner in which matches are identified, e.g., specific matching tags, a specific number of matching tags, a specific percentage of matching tags, etc.

A further advantage of the present systems and methods is the use of a computer to perform the initial matching of private posts, enables users to post about missed connections while maintaining strict privacy and anonymity.

A further advantage of the present systems and methods is the system may automatically derive tags to be used in the post matching process from the posts themselves, including deriving information to be used as tags from the post title, the post description, any user picture, etc.

A further advantage of the present systems and methods is the posts may include very precise location specific information to better facilitate matching missed connections, such as, for example, flight numbers, subway lines, bus lines, venues, places, streets.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims and enclosed drawings and exhibits.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of an embodiment of the system presented herein.

FIGS. 2A-2E are representative illustrations of a GUI through which a user initiates the creation of a post by selecting a location.

FIGS. 3A-3C are representative illustrations of a GUI through which a user selects tags to be associated with a post.

FIGS. 4A-4C are representative illustrations of a GUI through which a user selects tags to be associated with a post.

FIGS. 5A-5B are representative illustrations of a GUI through which a user defines tag matching parameters.

FIGS. 6A-6B are representative illustrations of a GUI through which a user receives notification of a match.

FIGS. 7A-7D are representative illustrations of a GUI through which a user reviews details of a pair of matching posts and chooses whether to provide consent to chat with the matched user.

FIGS. 8A-8C are representative illustrations of a GUI through which users of a matched pair chat.

FIGS. 9A-9C are representative illustrations of a GUI through which a user can provide permission for a matched user to view their profile.

FIGS. 10A-10D are representative illustrations of a GUI through which a user can create a profile.

### DETAILED DESCRIPTION OF THE INVENTION

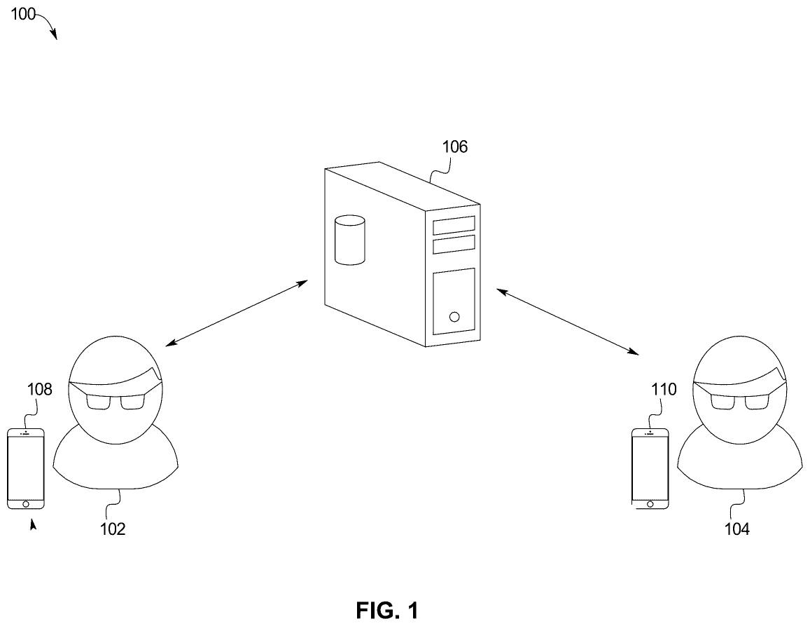

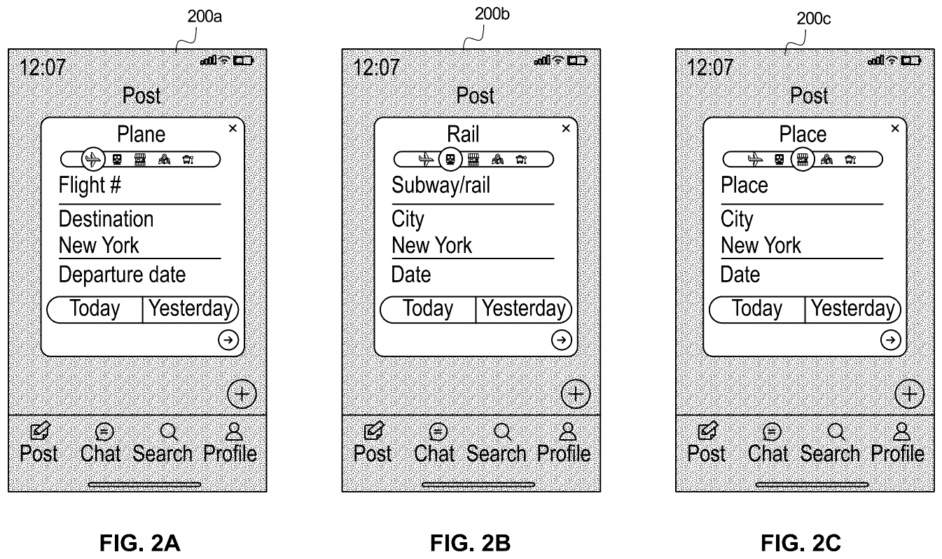

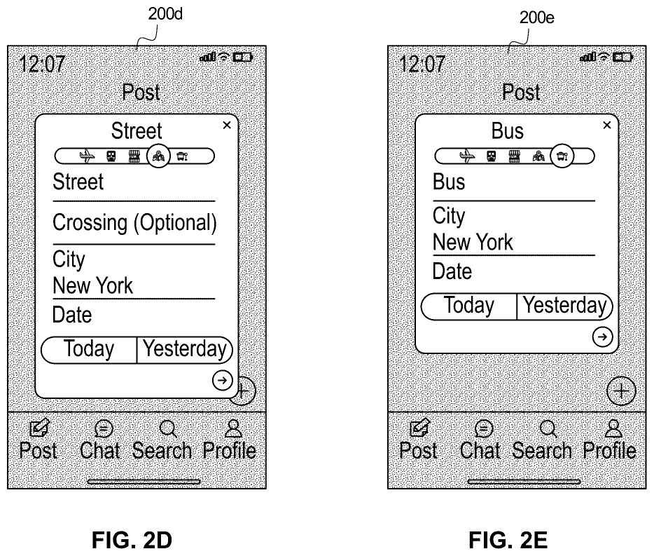

FIG. 1 illustrates a general example schematic of a system 100 enabling users to connect with one another after a real life missed connection after expressing mutual interest and consent while maintaining privacy, and FIGS. 2A-10D illustrate example user interfaces of the system 100 described herein. Specifically, the systems and methods taught herein enable users that have crossed paths in real life to anonymously and privately post to the system while providing parameters for the system to assist in identifying another user's corresponding matching post. Then, in response to the system identifying a matching post, the user can review the parameters of the match, choose whether to consent to an anonymous chat with the matched person, then, after consenting to a chat, choose whether to consent to share the user's profile with the matched person. The present systems and methods, and specifically the ordered sequence of steps in the systems and methods taught herein, is a key factor that enables the platform technology to provide the matching functions while maintaining the desired level of user control over privacy and anonymity.

Referring to FIG. 1, each of a first user 102 and a second user 104 accesses a server 106 through a first user device 108 and a second user device 110. The system 100 runs a software application, such as a mobile application and/or a desktop application, embodied in software on the server 106 to provide the functionality described herein. Each user accesses the system 100 through the application on via the user device to connect with other users.

In some embodiments, the software application is a mobile application. Each user device may install the system software on his or her end user device through Apple's App Store, the Android Market, or another app store. The user device may include a wireless communication subsystem to communicate with the server 106 running the system software. The software application may also be a desktop application similarly communicating with the server 106 running the system software.

FIGS. 2A-2E illustrate example embodiments of graphical user interfaces 200a-200e through which a user initiates the creation of a post by selecting a location of the missed connection. For example, the system 100 may provide a user interface specific to the type of location of the missed connection being on a plane, rail, place (such as a restaurant, park, or concert venue), address, or bus/transit. Once the user selects the type of location, he or she enters additional details such as a flight number for a plane type of location, a restaurant for a place type of location, a train line for a rail type of location. The details also include a date and time of the missed connection. In other embodiments, additional details may be pertinent and included.

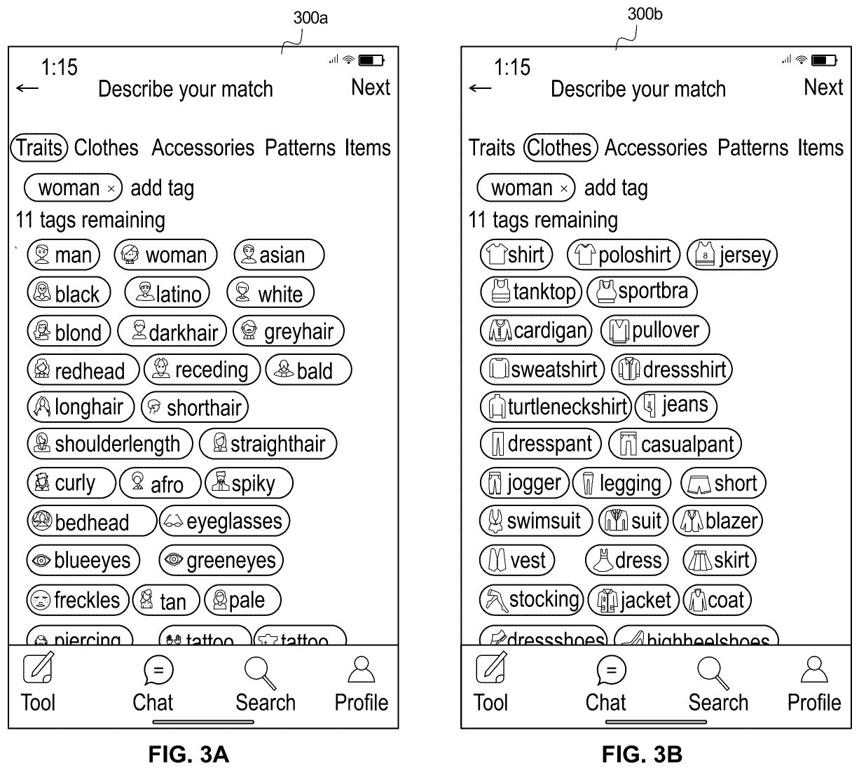

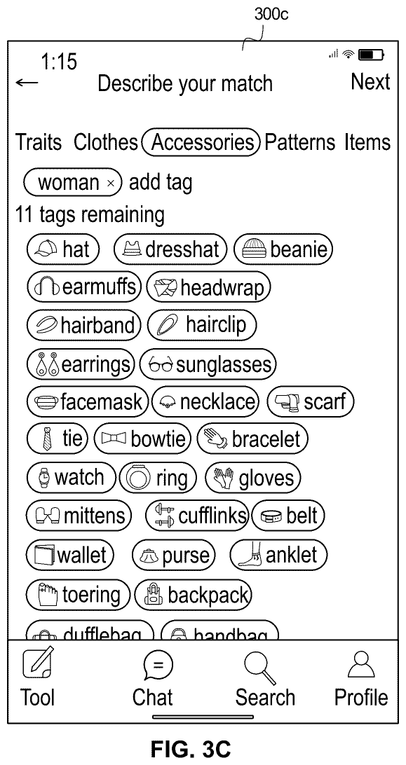

FIGS. 3A-3C illustrate example embodiments of graphical user interfaces 300a-300c through which the user selects tags to be associated with a post. The associated tags may be entered manually by the user or determined automatically by the system from the title or description entered or the user profile selected. In the illustrated embodiment, the user interface includes a category menu, enabling the user to select a category of tags to review and select. For example, the interfaces include the categories of traits, clothes, accessories, patterns, and items. FIGS. 3A-3C demonstrate specific examples of tags for each category. Each user can select tags to describe himself or herself as well as their match. In other embodiments, additional or fewer categories may be provided.

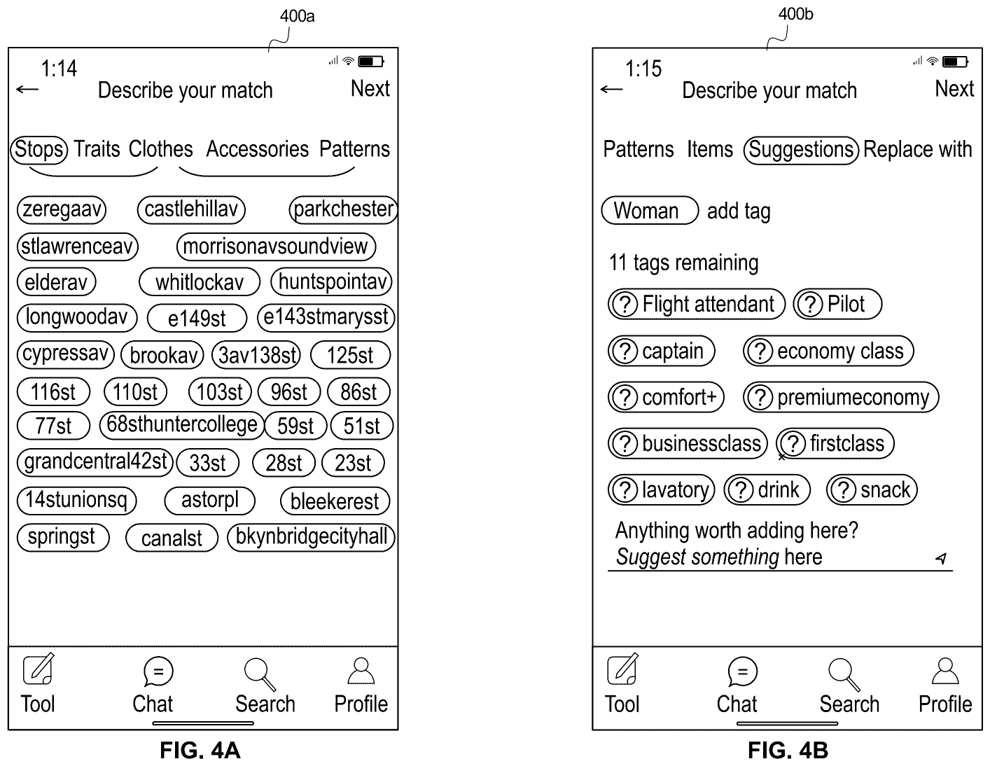

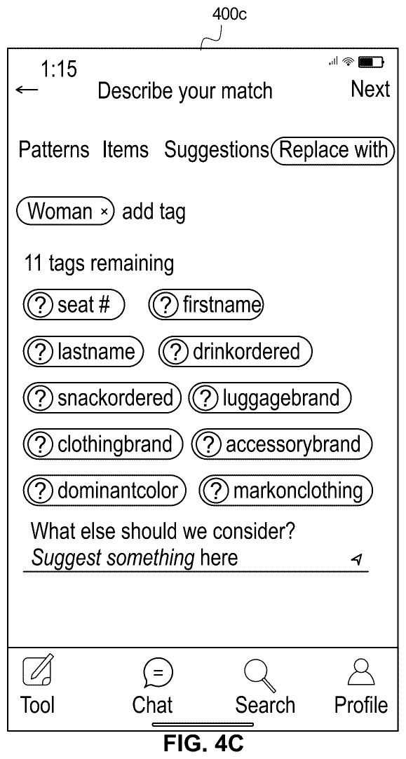

FIGS. 4A-4C illustrate example embodiments of graphical user interfaces 400a-400c through which the user selects additional tags to be associated with a post. These user interfaces enable the user to select tags specific to the situation, such as a missed connection at a specific street intersection. The system 100 may also suggest tags, such as first class seating or economy class seating tags for a missed connection on a flight. FIGS. 4A-4C include examples of additional tags.

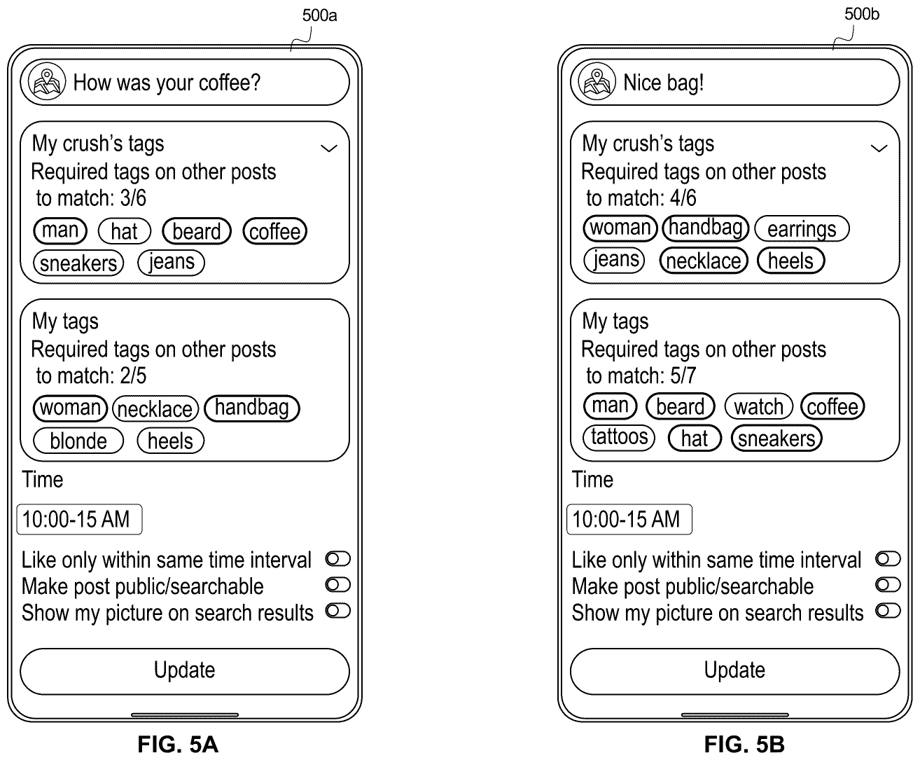

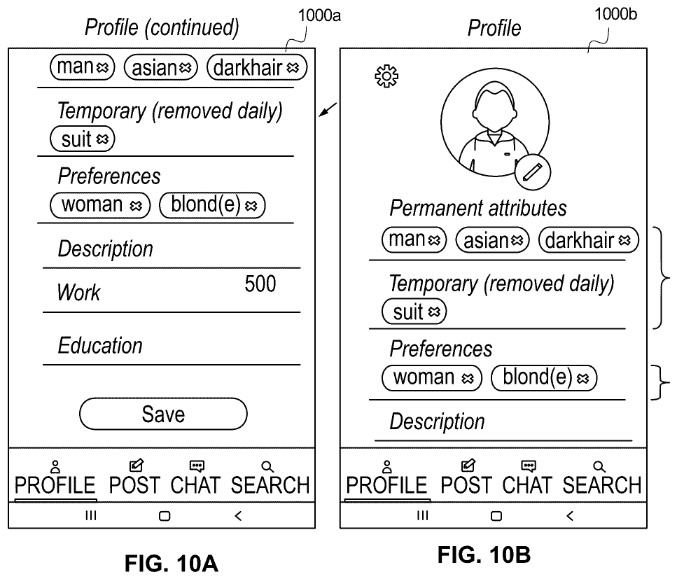

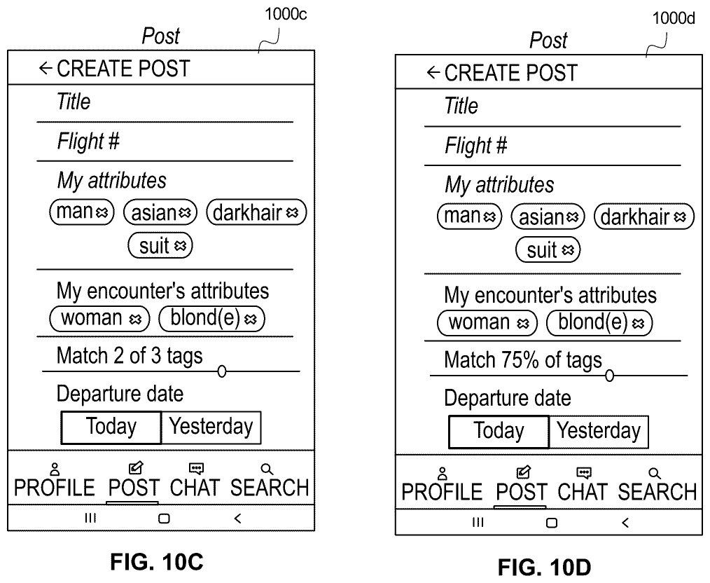

Once tags are selected, the user can define the tag matching parameters through user interfaces 500a, 500b such as the user interfaces of FIGS. 5A-5B. Through these example interfaces, the user can set boundaries around requirements for allowing the match to proceed. For example, the user can require that three out of six of the other person's tags must match in order to proceed to the step of receiving a notification that a match has been made. In other embodiments, the user can require a percentage of the tags match (see FIG. 10D) or any other suitable parameter. The user interface can also include optional requests selected through a button or toggle element. Example optional requests include requiring the time intervals to be matching, making a post public/searchable, or showing the user's photo on search results.

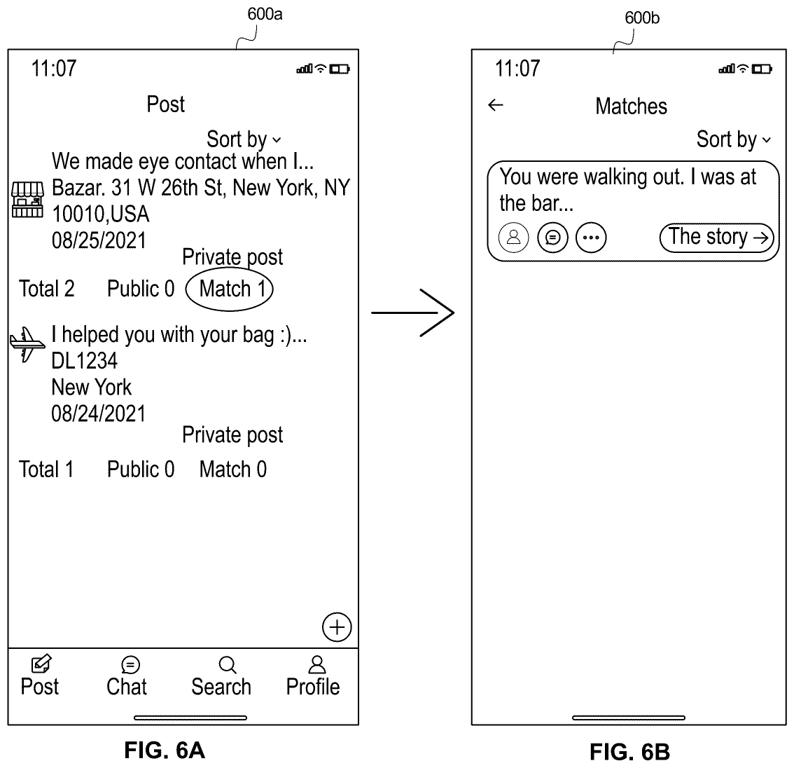

Once the system 100 has identified a match that complies with the tag matching parameters of each user, the system 100 will provide notification of a match to each user through the example user interfaces 600a, 600b of FIGS. 6A-6B. In the post listing user interface 600a of FIG. 6A, the user can monitor how many missed connections posts have been made. Each listed post includes an indication of whether the post has a match. The post's match user interface 600b shown in FIG. 6B includes a list of all matches for the post, enabling the user to select and view each match individually.

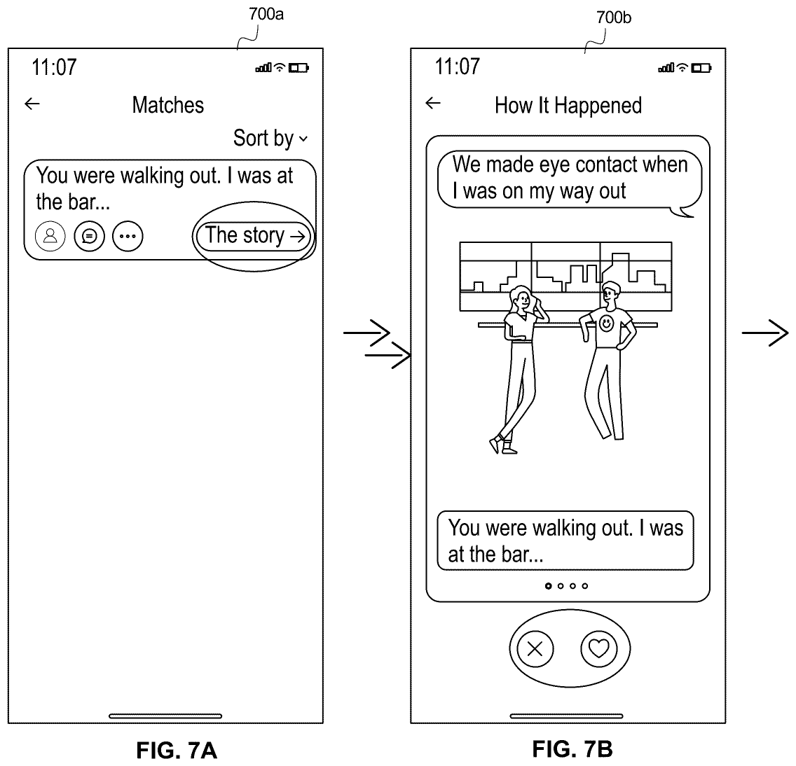

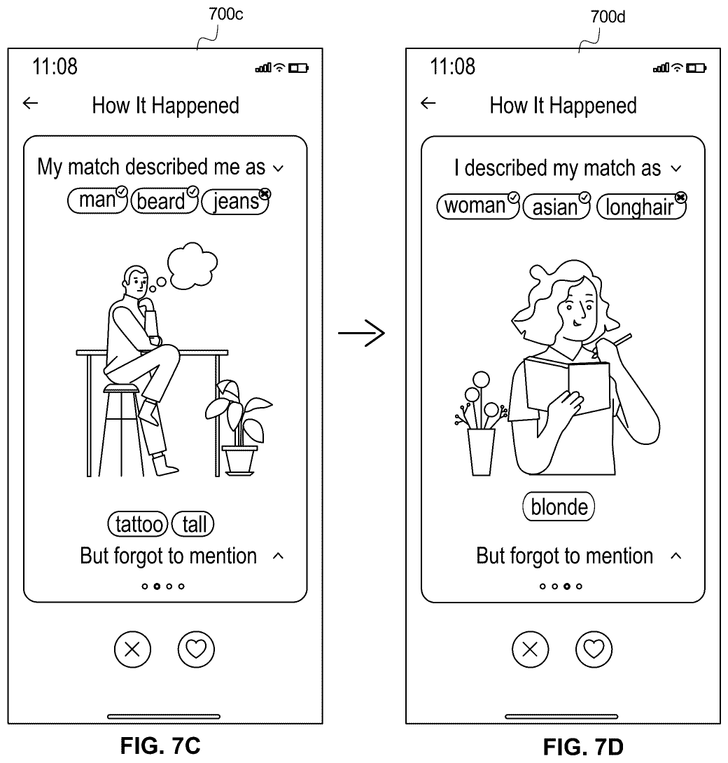

Once a match is made, each user can view the story of the match and decide whether to move forward with allowing the users to chat or connect. FIGS. 7A-7D illustrate example embodiments of graphical user interfaces 700a-700d through which the user reviews details of a pair of matching posts and chooses whether to provide consent to chat with the matched user. In the illustrated embodiment, the system 100 allows the user to view the story of how the missed connection occurred through a number of illustrative user interfaces demonstrating different points of the story. Each individual illustration of the story may include additional tags that each user can select. The illustrated embodiment also gives the user the option to consent to the next step of the process by selecting a heart button or the option to reject the missed connection and prevent any further sharing of information.

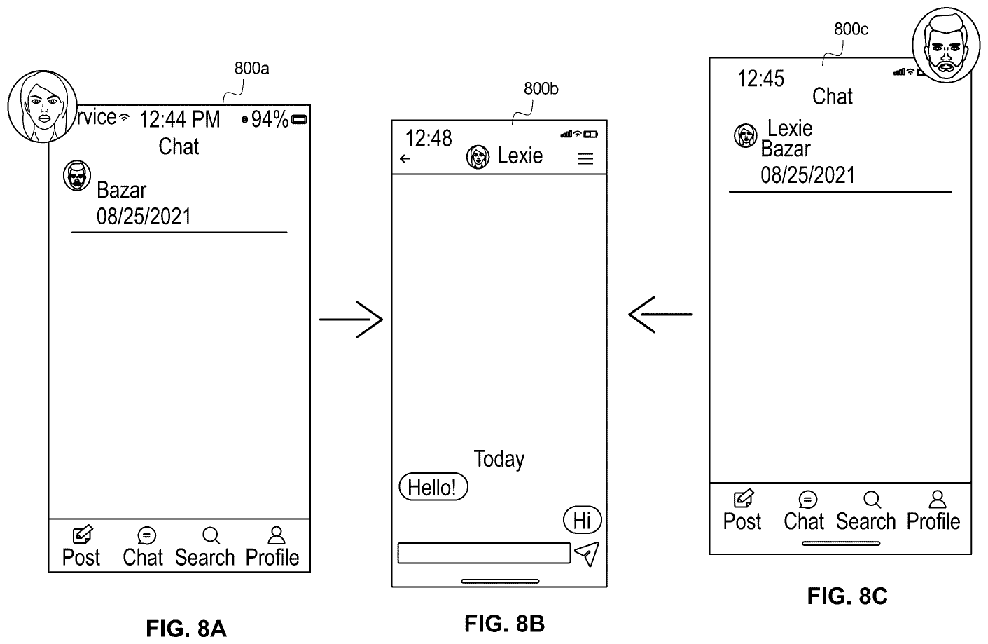

If both users consent to the story of the missed connection, the users then proceed to engage in a chat without sharing any identifying information. FIGS. 8A-8C illustrate example embodiments of graphical user interfaces 800a-800c through which users of a matched pair chat. In the illustrated embodiment, the first user and the second user engage in a matched pair chat, with the users maintaining anonymity.

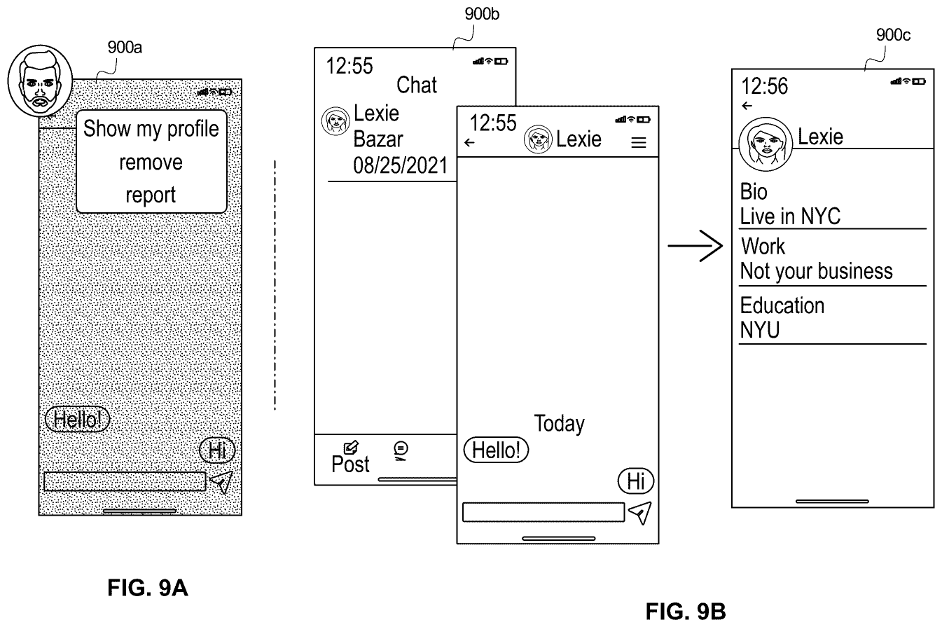

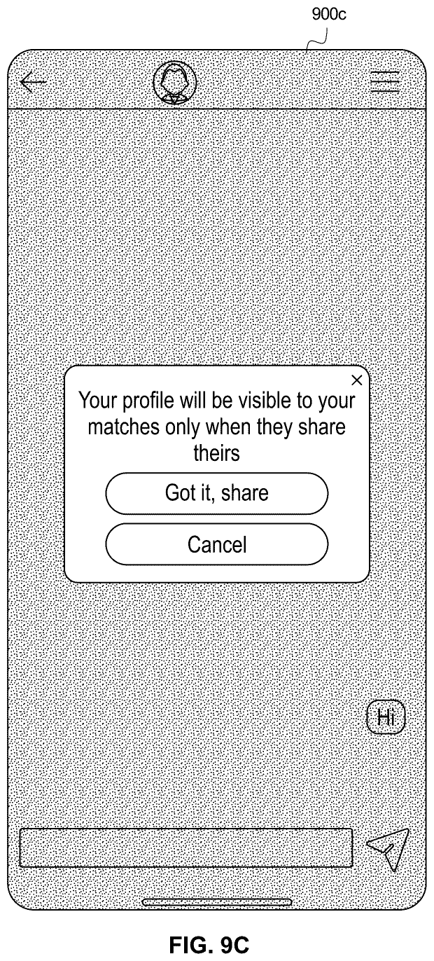

During the chat, the users agree to share profile information. FIGS. 9A-9C illustrate example embodiments of graphical user interfaces 900a-900c through which the user can provide permission for a matched user to view their profile. For example, during the matched pair chat shown in FIGS. 8A-8C, each user has the option to share their respective profile with the other user. In some embodiments, the system 100 may only share user profiles once both the first and the second user consent to sharing their respective profile information. FIG. 9C illustrates the additional screening user interface 900c indicating that mutual consent is required to share profile information.

Further, FIGS. 10A-10D illustrate example embodiments of graphical user interfaces 1000a-1000d through which the user can create and manage a profile. In some embodiments, permanent and/or temporary attributes of a user's profile are defaulted in the user attributes of the post to expedite the creation of the post. The attributes may be automatically populated in the draft post user interface as shown in FIGS. 10C and 10D, and the user may have the option to remove them prior to posting.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

What is claimed is:

1. A computing device comprising:
one or more processors; and
one or more computer-readable devices in communication with the one or more processors, the one or more computer-readable devices including instructions that when executed by the one or more processors cause the one or more processors to perform operations comprising:
receiving a first post from a first user device associated with a first user account, wherein the first post includes:
a first title or a first description;
a first location;
a first time interval; and
one or more first tags;
receiving a second post from a second user device associated with a second user account, wherein the second post includes:
a second title or a second description;
a second location;
a second time interval; and
one or more second tags;
identifying whether there is a match between the first post and the second post, wherein a match is determined when a specific set of tag matching parameters are satisfied between the first post and the second post;
when the specific set of tag matching parameters are not satisfied between the first post and the second post, not allowing the first user account to view the second post, not allowing the second user account to view the first post, not allowing chat functionality between the first user account and the second user account, and not allowing profile viewing between the first user account and the second user account;
when the specific set of tag matching parameters are satisfied between the first post and the second post, providing both the first user account and the second user account access to details related to the manner in which the tag matching parameters were satisfied, providing the first user account access to view the second post, providing the second user account access to view the first post, providing the first user account an option to enable chat functionality between the first user account and the second user account; and providing the second user account to enable chat functionality between the first user account and the second user account;
after providing both the first user account and the second user account access to details related to the manner in which the tag matching parameters were satisfied, providing the first user account access to view the second post, providing the second user account access to view the first post, providing the first user account an option to enable chat functionality between the first user account and the second user account; and providing the second user account to enable chat functionality between the first user account and the second user account, when the one or more processers do not receive consent to enable chat functionality between the first user account and the second user account from both the first user account and the second user account, not allowing chat functionality between the first user account and the second user account and not allowing profile viewing between the first user account and the second user account;
when the one or more processers receive consent to enable chat functionality between the first user account and the second user account from both the first user device and the second user device, providing chat functionality between the first user account and the second user account;
after providing chat functionality between the first user account and the second user account, when the one or more processers do not receive consent to share the first user account profile with the second user account from the first user device and do not receive consent to share the second user account profile with the first user account from the second user account device, not allowing profile viewing between the first user account and the second user account;
when the one or more processers receive consent to share the first user account profile with the second user account from the first user device and receive consent to share the second user account profile with the first user account from the second user account device, allowing profile viewing between the first user account and the second user account.

2. The computing device of claim 1, wherein the one or more first tags include one or more tags related to the first user and one or more tags related to a first missed connection and the one or more second tags include one or more tags related to the second user and one or more tags related to a second missed connection.

3. The computing device of claim 2, wherein the one or more first tags and the one or more second tags each include permanent and nonpermanent attributes.

4. The computing device of claim 2, wherein the one or more first tags and the one or more second tags include situational context tags that do not relate specifically to any of the first user, the second user, the first missed connection, or the second missed connection.

5. The computing device of claim 4, wherein the situational context tags relate to a location.

6. The computing device of claim 4, wherein the situational context tags relate to a time interval.

7. The computing device of claim 1, wherein the first user account determines the tag matching parameters for the first post.

8. The computing device of claim 7, wherein the second user account determines the tag matching parameters for the second post.

9. The computing device of claim 7, wherein the computing device determines the tag matching parameters for the second post.

10. The computing device of claim 1, wherein the computing device determines the tag matching parameters for the first post and the second post.

11. The computing device of claim 1, wherein the tag matching parameters include specific tags that must match between the first post and the second post in order to satisfy the tag matching parameters.

12. The computing device of claim 1, wherein the tag matching parameters include a number of tags that must match between the first post and the second post in order to satisfy the tag matching parameters.

13. The computing device of claim 1, wherein the tag matching parameters include a percentage of tags that must match between the first post and the second post in order to satisfy the tag matching parameters.

14. A computer-implemented method, comprising:
receiving in a computing device a first post from a first user device associated with a first user account, wherein the first post includes:
a first title or a first description;
a first location;
a first time interval; and
one or more first tags;
receiving the computing device a second post from a second user device associated with a second user account, wherein the second post includes:
a second title or a second description;
a second location;
a second time interval; and
one or more second tags;
identifying whether there is a match between the first post and the second post, wherein a match is determined when a specific set of tag matching parameters are satisfied between the first post and the second post;
when the specific set of tag matching parameters are not satisfied between the first post and the second post, not allowing the first user account to view the second post, not allowing the second user account to view the first post, not allowing chat functionality between the first user account and the second user account, and not allowing profile viewing between the first user account and the second user account;
when the specific set of tag matching parameters are satisfied between the first post and the second post, providing both the first user account and the second user account access to details related to the manner in which the tag matching parameters were satisfied, providing the first user account access to view the second post, providing the second user account access to view the first post, providing the first user account an option to enable chat functionality between the first user account and the second user account; and providing the second user account to enable chat functionality between the first user account and the second user account;
after providing both the first user account and the second user account access to details related to the manner in which the tag matching parameters were satisfied, providing the first user account access to view the second post, providing the second user account access to view the first post, providing the first user account an option to enable chat functionality between the first user account and the second user account; and providing the second user account to enable chat functionality between the first user account and the second user account, when the computing device does not receive consent to enable chat functionality between the first user account and the second user account from both the first user account and the second user account, not allowing chat functionality between the first user account and the second user account and not allowing profile viewing between the first user account and the second user account;
when the computing device receives consent to enable chat functionality between the first user account and the second user account from both the first user device and the second user device, providing chat functionality between the first user account and the second user account;
after providing chat functionality between the first user account and the second user account, when the computing device does not receive consent to share the first user account profile with the second user account from the first user device and do not receive consent to share the second user account profile with the first user account from the second user account device, not allowing profile viewing between the first user account and the second user account;
when the computing device receives consent to share the first user account profile with the second user account from the first user device and receive consent to share the second user account profile with the first user account from the second user account device, allowing profile viewing between the first user account and the second user account.

15. The computer-implemented method of claim 14, wherein the first user account determines the tag matching parameters for the first post.

16. The computer-implemented method of claim 15, wherein the second user account determines the tag matching parameters for the second post.

17. The computer-implemented method of claim 15, wherein the computing device determines the tag matching parameters for the second post.

18. The computer-implemented method of claim 14, wherein the computing device determines the tag matching parameters for the first post and the second post.

19. The computing device of claim 1, wherein the one or more first tags include one or more tags related to the first user and one or more tags related to a first missed connection and the one or more second tags include one or more tags related to the second user and one or more tags related to a second missed connection.

20. The computing device of claim 1, wherein the tag matching parameters include specific tags that must match between the first post and the second post in order to satisfy the tag matching parameters, a number of tags that must match between the first post and the second post in order to satisfy the tag matching parameters, or a percentage of tags that must match between the first post and the second post in order to satisfy the tag matching parameters.
